(19) United States
(12) Patent Application Publication
(10) Pub. No.: US 2002/0167195 A1
(43) Pub. Date: Nov. 14, 2002

(54) Door module for motor vehicles

(76) Inventors: Thomas Nagel, Weinbach (DE); Martin Bunnemann, Dornburg (DE)

Correspondence Address: U.S. Philips Corporation, 580 White Plains Road, Tarrytown, NY, 10591, US

(21) Appl. No.: 10/084,851

(22) Filed: Feb. 26, 2002

(30) Foreign Application Priority Data
Feb. 27, 2001 (DE) 10109452.3

(51) Int. Cl. B62D 25/04

(52) U.S. Cl. 296/146.5

(57) ABSTRACT

The invention relates to a door module (1) for motor vehicles and the manufacture of such a module. The invention is characterized in that the door module (1) is intended for fixation to a door (2) of a motor vehicle and has a synthetic material carrier (1a) as a carrier element, and various function elements and/or reinforcements (11) fixed by synthetic material injection-moulding or connected to the synthetic material carrier (1a) by means of injection-moulded synthetic material.

The present invention relates to a door module for motor vehicles.

The doors of modern motor vehicles have more and more functions. For example, controls are provided for electric window lifters, electric mirror adjustment or electric seat adjustment. There are also components such as speakers, storage compartments, pockets and holders for a central locking mechanism. These function components must partly be supplied with electric power or have connecting cables for the exchange of electric control signals. Therefore, cables must also be placed in the door. In order to keep manufacturing costs as low as possible, vehicle manufacturers have switched to dividing the door into several components. The main component is of course the car door itself, which usually consists of steel plate, aluminium or synthetic material, and a carrier module that is fixed to the inner side of the car door and carries the controls and function elements. This carrier module is covered with a door lining from the passenger space of a motor vehicle.

The carrier modules today are almost always manufactured by suppliers and delivered as complete units to the assembly line of a car manufacturer. Due to pressure of prices on suppliers, these are forced to seek the lowest cost solutions with a high degree of automation in the manufacturing process.

DE 198 33 185 A1 describes the structure of such a carrier module. The carrier module is formed in one piece and has a self-supporting carrier plate of metal as a main component. Function elements of synthetic material are injection-moulded onto this carrier plate, which elements are connected to the carrier plate in one working step.

It is an object of the present invention to further simplify the manufacture of a door module for motor vehicles and to allow integration of further functions.

According to the invention, this object is achieved in that the door module is intended for fixation to a door of a motor vehicle and has a synthetic material carrier as a carrier element, and various function elements and/or reinforcements fixed by synthetic material injection-moulding or connected to the synthetic material carrier by means of injection-moulded synthetic material.

As compared with a metal carrier, the synthetic material carrier has the great advantage that it is simpler and faster and cheaper to produce. Furthermore, a synthetic material carrier is substantially lighter which lowers the overall weight of the motor vehicle. Also synthetic material carriers can be manufactured without problems in all possible shapes. Together with the injection-moulded reinforcements, synthetic material carriers offer a stability and strength comparable to that of metal carriers. As the reinforcements together with the function elements are fixed to the synthetic material carrier in one working step, the reinforcements constitute no drawback as compared with a metal carrier, which does not require such reinforcements, since no additional working step is required.

The embodiment defined in claim 2 constitutes a particularly favourable method of manufacturing synthetic material components. The form of a synthetic material carrier is thus designed flexibly, and also mass production is possible. The tray-like shape increases the stability and torsional rigidity of the entire door module.

With the embodiment defined in claim 3, the process of manufacturing the entire door module is simplified. Seals, buffer elements and even locks are applied by injection moulding synthetic material onto the synthetic material carrier. This is possible with a metal carrier by using only the more expensive outsert technique (metal-synthetic material joint). In contrast, the injection moulding of synthetic material onto synthetic material carriers is considerably easier.

The embodiments defined in claims 4 and 5 increase the rigidity and stability of a door module. As the door module must be sealed against moisture from the car door and the door lining, a good seal as well as a high stability are required in the area where the door module meets the car door or door lining. Otherwise, the door module can twist and the seal creates gaps through which moisture can penetrate. For this reason, the areas concerned are provided with a channel in the door module, which channel holds a metal wire. This metal wire ensures a high stability and prevents twisting of the door module in these areas and, together with the seals, prevents the penetration of moisture into the door module.

The embodiments defined in claims 6 to 8 relate to a method of manufacturing a door module according to the invention, claims 9 and 10 relate to a car door and a motor vehicle, respectively, with a door module according to the invention.

An embodiment of the present invention will now be elucidated with reference to the Figures.

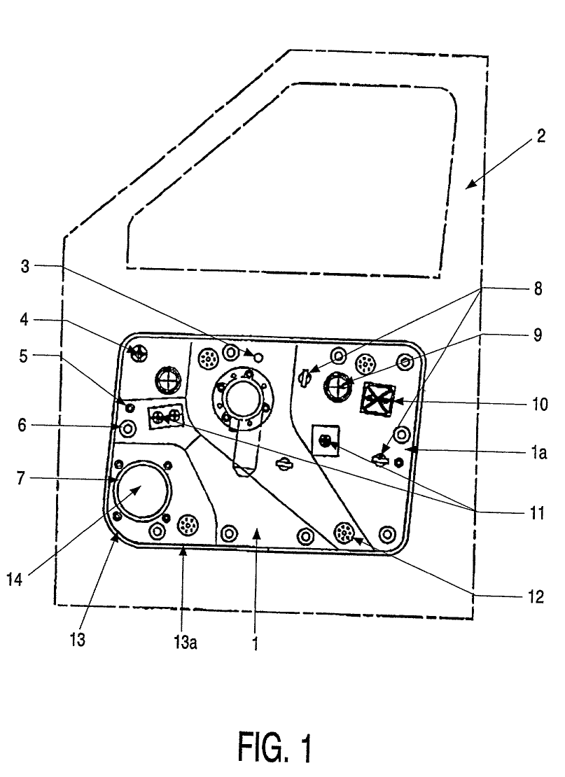

FIG. 1 is a side elevation of a door module according to the invention in a car door,

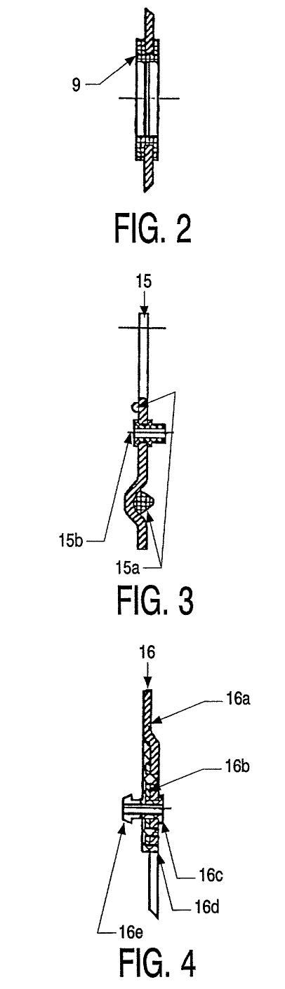

FIG. 2 shows as an exemplary function element a cable bushing of injection-moulded synthetic material,

FIG. 3 shows a speaker mounting, and

FIG. 4 shows a motor fixing.

A car door 2 shown in FIG. 1 contains the door module 1 according to the invention. The door module 1 is mounted on the inner side of the car door 2. Towards the passenger space, the door module 1 is coated with a door lining (not shown). In the manufacture of door module 1, several components are joined together. The door module 1 thus consists of a basic carrier 1a, which is a cut, deep-drawn or blanked synthetic material part. This synthetic material carrier 1a is provided with various function elements and reinforcements. This is done preferably by injection moulding of synthetic material. In the upper area, the synthetic material carrier has cable holders 8 and bushes 9. The cable holders 8 are designed as cable clips in this case. Thus, the cables for power supply and control of electric components such as electric window lifters can simply be pushed or clipped into the cable holders 8.

To establish the distance between the door 2 and door module 1 or between door module 1 and door lining, flexible buffers 3 and centring bolts 5 are injection moulded onto the synthetic material carrier 1a. As reinforcement elements, metal inserts 12 and door handle fixings 11 with metal-reinforced insert and metal-reinforced screw points 6 are provided. As the door module must be reversibly connected to the door lining of the door 2 in order to allow any maintenance work on the electric components inside the door module 1, the door lining is attached to the door module 1 by means of twist locks 4. One such twist lock 4 is also injection moulded by means of synthetic material onto the door module. The electric components to be installed in door module 1 include, for example, electric window lifters or the central locking control. For the central locking, holders 10 of synthetic material are also injection moulded onto the door module 1.

Electric components must be protected against moisture, which requires a seal between the door module 1 and car door 2 and between door module 1 and door lining. For this reason, the door module has seals 7 at its edges. In order to achieve a reliable seal along the peripheral edge of door module 1, its peripheral edge has a channel 13a, which holds a wire 13. This wire 13 stabilises the synthetic material carrier 1a in the critical edge area and, together with the seal 7, ensures that no moisture can penetrate into the door module 1. If the door module has large openings 14, e.g. for voluminous loud speakers, these openings 14 may have a wire-reinforced channel in addition to a seal 7.

FIGS. 2-4 show individual injection-moulded function elements in an enlarged view. In FIG. 2 a cable bush 9 consists of soft rubber, which is injection-moulded onto the synthetic material carrier 1a. In the same way, other installation openings can be made. In FIG. 3 a speaker mounting 15 may additionally have metal components 15b for reinforcement. In addition, a sealing cord 15a of soft rubber is injection moulded on, which, after mounting of the speaker, seals this speaker from the door module 1. To fix the electric motors, special motor fixings 16 are provided, one example is shown in FIG. 4. Such a motor fixing 16 consists of a synthetic material part 16a and a metal reinforcement 16b as basic elements. Furthermore, the metal reinforcement 16b is surrounded by injection-moulded synthetic material 16c on one side and thus constitutes the motor support. For sealing purposes, a peripheral soft rubber cord 16d is injectioned on so that no moisture reaches the inner side of the door module 1. If the motor drives a cable drum, a holder 16e is provided therefor, which holder is injection moulded onto the metal insert reinforcement 16b. This holder 16a is formed as a clip so that a housing with a cable drum can be mounted by simple pushing and clipping.

The synthetic material components and reinforcement elements are inseparably connected to the synthetic material carrier la in one working step, whereby a door module can be manufactured cheaply and quickly and nonetheless has a sufficient stability due to the reinforcement elements.

1. A door module (1) for motor vehicles, intended for fixation to a door (2) of a motor vehicle and having a synthetic material carrier (1a) as a carrier element, and various function elements and/or reinforcements (11) fixed by synthetic material injection moulding or connected to the synthetic material carrier (1a) by means of injection-moulded synthetic material.

2. A door module (1) as claimed in claim 1, characterized in that the synthetic material carrier (1a) is formed tray-like and is a deep-drawn or stamped synthetic material component.

3. A door module (1) as claimed in claim 1, characterized in that the function elements are buffer elements (3), seals (7), locks (4) or fixings (8, 10, 11, 12, 6) which can be manufactured by injection moulding synthetic material onto the synthetic material carrier (1a).

4. A door module (1) as claimed in claim 1, characterized in that metal wires (13) for stabilising purposes are fastened in or on the synthetic material carrier (1a).

5. A door module (1) as claimed in claim 4, characterized in that the door module (1) has a peripheral channel (13a), which is intended to hold a wire (13) to seal the door module (1) from a door of a motor vehicle or a door lining.

6. A method of manufacturing a door module (1) for transport means, in which function elements and reinforcements (11) are inseparably connected to a synthetic material carrier (1a) in one working step.

7. A method as claimed in claim 6, characterized in that the synthetic material carrier (1a) is spot-connected to the reinforcement elements (11) by synthetic material injection moulding.

8. A method as claimed in claim 6, characterized in that function elements or reinforcement elements (11) are injection moulded onto the synthetic material carrier (1a).

9. A door of a motor vehicle with a door module (1) which is fixed to the door (2) of a motor vehicle and has a synthetic material carrier (1a) as a carrier element, and various function elements and/or reinforcements (11) fixed by synthetic material injection moulding or connected to the synthetic material carrier (1a) by means of injection-moulded synthetic material.

10. A motor vehicle with a door module (1) intended for fixation to a door (2) of a motor vehicle and having a synthetic material carrier (1a) as a carrier element, and various function elements and/or reinforcements (11) fixed by synthetic material injection moulding or connected to the synthetic material carrier (1a) by means of injection-moulded synthetic material.
